(19) United States
(12) Patent Application Publication
(10) Pub. No.: US 2024/0176807 A1
(43) Pub. Date: May 30, 2024

(54) MACHINE LEARNING BASED SOLUTION FOR SKILL AND RELATED SKILLS

(71) Applicant: SAP SE, Walldorf (DE)

(72) Inventor: Sumanth Pulugu, Hyderabad (IN)

(21) Appl. No.: 18/071,791

(22) Filed: Nov. 30, 2022

(51) Int. Cl. G06F 16/33; G06F 16/335; G06F 16/338; G06F 40/289

(52) U.S. Cl. CPC G06F 16/3344; G06F 16/337; G06F 16/338; G06F 40/289

(57) ABSTRACT

The present disclosure involves systems, software, and computer implemented methods for generating a skill and related skill dataset based on machine learning. One example method includes receiving, by a server, textual data. The server pre-processes the textual data to obtain pre-processed textual data, and trains a machine learning model using the pre-processed textual data. The server extracts a plurality of skills from the pre-processed textual data, where each skill of the plurality of skills is a word or a phrase in the pre-processed textual data. The server generates a first plurality of skill pairs using the plurality of skills, and processes the first plurality of skill pairs through the machine learning model to generate a second plurality of skill pairs, where the second plurality of skill pairs is a subset of the first plurality of skill pairs.

### TECHNICAL FIELD

The present disclosure relates to computer-implemented methods, software, and systems for machine learning based solutions for skill and related skills.

### BACKGROUND

A person may explicitly mention certain skills in his or her portfolio (such as a resume), but may neglect to mention some other skills because he or she may not know his or her possession of these skills or the importance of these skills. For example, a person with both problem-solving and critical thinking skills may only mention problem-solving but not critical-thinking in his or her resume. A skill and related skill dataset may be helpful to bridge this skill gap.

### SUMMARY

The present disclosure involves systems, software, and computer implemented methods for generating a skill and related skill dataset based on machine learning. An example method includes receiving, by a server, textual data. The textual data is pre-processed by the server to obtain pre-processed textual data. A machine learning model is trained by the server using the pre-processed textual data. A plurality of skills are extracted by the server from the pre-processed textual data, where each skill of the plurality of skills is a word or a phrase in the pre-processed textual data. A first plurality of skill pairs are generated by the server using the plurality of skills. The first plurality of skill pairs are processed by the server through the machine learning model to generate a second plurality of skill pairs, where the second plurality of skill pairs is a subset of the first plurality of skill pairs.

A first feature, combinable with any of the following features, further comprising identifying a skill input by a user, generating a list of related skills for the skill input by the user based on the second plurality of skill pairs, automatically identifying one or more related skills from the list of related skills to the user, and providing, for presentation to the user, the identified one or more related skills.

A second feature, combinable with any of the previous or following features, wherein the skill input by the user is a skill of the user, and generating the list of related skills comprises querying the second plurality of skill pairs with the skill input by the user, and receiving a plurality of related skills, wherein each related skill of the plurality of related skills and the skill input by the user is a pair in the second plurality of skill pairs, and generating the list of related skills based on the plurality of related skills.

A third feature, combinable with any of the previous or following features, wherein the textual data includes at least one of a plurality of job descriptions, associated with different industries and different job titles, or a plurality of resumes, and is received from a third-party system.

A fourth feature, combinable with any of the previous or following features, wherein each skill pair of the first plurality of skill pairs includes two skills extracted from a same job description or a same resume.

A fifth feature, combinable with any of the previous or following features, wherein processing the first plurality of skill pairs through the machine learning model comprises, for each skill pair of the first plurality of skill pairs, calculating a cosine similarity score for the skill pair using the machine learning model, and adding the skill pair to the second plurality of skill pairs if the cosine similarity score for the skill pair is higher than a threshold.

A sixth feature, combinable with any of the previous or following features, wherein the threshold is 70%.

A seventh feature, combinable with any of the previous or following features, wherein pre-processing the textual data comprises at least one of stopwords removal, Unicode normalization, or unwanted character removal.

An eighth feature, combinable with any of the previous or following features, wherein the machine learning model includes a word2vec model.

A ninth feature, combinable with any of the previous or following features, further comprising at least one of manually removing one or more skills from the plurality of skills, manually removing one or more skill pairs from the first plurality of skill pairs, or manually adding one or more skill pairs to the second plurality of skill pairs.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for applying machine learning based solutions for skill and related skills.

FIG. 2 is a flow diagram of an example process for generating skill pairs based on a machine learning model.

FIG. 3 is a flowchart of an example method for generating a skill and related skill dataset based on machine learning.

FIG. 4 is a flowchart of an example method for identifying related skills to an input skill.

FIG. 5 is an example snapshot of presenting related skills to an input skill.

### DETAILED DESCRIPTION

The following detailed description describes machine learning based solutions for skill and related skills. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

A person may explicitly mention certain skills in his or her portfolio (such as resume), but may neglect to mention some other skills because he or she may not know his or her possession of these skills or the importance of these skills. For example, a person with both C and C++ skills may only mention C in his or her resume, but failed to mention C++. Alternatively, a term used for a particular skill listed on a resume may be different than or a variation of a term used in the industry or by a company or enterprise. A valid skill and related skill dataset can help to bridge this skill gap by suggesting related skills for the person to consider. Skill and related skills can be manually collected and connected to form the skill and related skill dataset. For example, related skills of a particular skill can be found from nearby words of the particular skill in a resume and/or a job description.

Different from manual collection and user-provided connections between skills, this specification leverages machine learning and Natural Language Processing (NLP) techniques to automatically generate a skill and related skill dataset. For example, the machine learning based solution can automatically observe a large corpus of text and establish relations or connections between skills based on their occurrence in the text and context rather than simple co-occurrence of the skills in the text. If two skills occurred in a same job description of the text and their similarity score (e.g., based on any cosine similarity comparison methodology) is greater than a predefined value by taking the entire text into consideration, the two skills may be considered related to each other. In doing so, the machine learning based solution can be employed to better understand the skill gap of a person and to recommend missing skills based on the person's listed skills. In addition, the machine learning based solution can be applied to different industries and bigger datasets, and can reduce significant manual effort to generate the skill and related skill dataset. Similar technologies can be used in any interpersonal solution, including suggesting related skills to be listed in employee resumes, recommending related skills for employee training, recommending positions in fields of related skills, and any other suitable implementation.

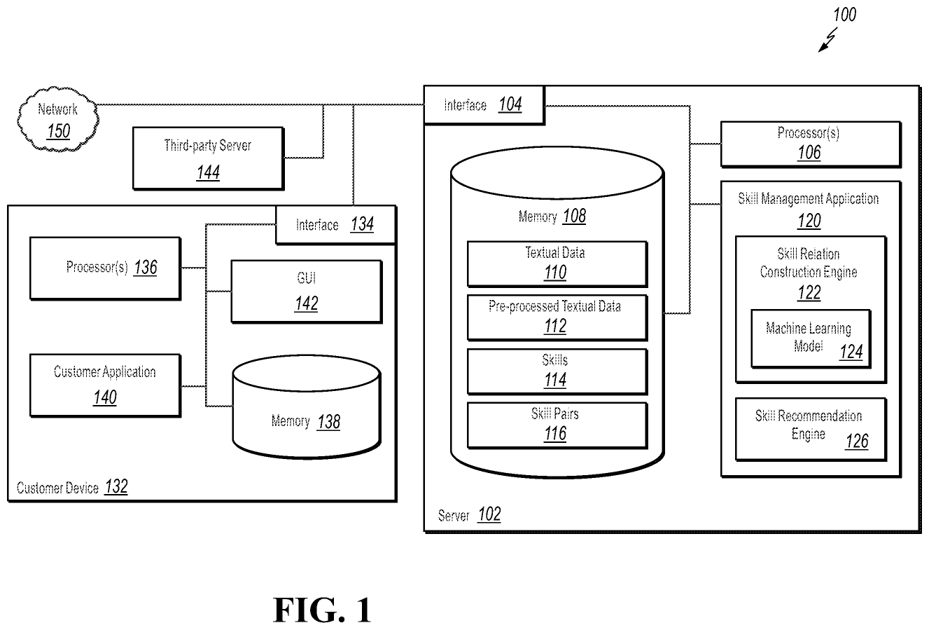

Turning to the illustrated embodiment, FIG. 1 is a block diagram illustrating an example system 100 for applying machine learning based solutions for skill and related skills. Specifically, the illustrated system 100 includes or is communicably coupled with a server 102, a customer device 132, a third-party server 144, and a network 150. Although shown separately, in some implementations, functionality of two or more systems or servers may be provided by a single system or server. In some implementations, the functionality of one illustrated system, server, or component may be provided by multiple systems, servers, or components, respectively.

As used in the present disclosure, the term “computer” is intended to encompass any suitable processing device. For example, although FIG. 1 illustrates a single server 102 and a single customer device 132, the system 100 can be implemented using a single, stand-alone computing device, two or more servers, or two or more customer device. Indeed, the server 102 may be any computer or processing device such as, a blade server, general-purpose personal computer (PC), Mac®, workstation, UNIX-based workstation, or any other suitable device. In other words, the present disclosure contemplates computers other than general-purpose computers, as well as computers without conventional operating systems. Further, the server 102 and the customer device 132 may each be adapted to execute any operating system, including Linux, UNIX, Windows, Mac OS®, Java™, Android™, iOS, or any other suitable operating system. According to one implementation, the server 102 may also include or be communicably coupled with a communication server, an e-mail server, a web server, a caching server, a streaming data server, and/or other suitable servers or computers.

In general, server 102 may be any suitable computing server or system executing applications related to requests for performing employee management including, for example, related skills recommendation. The server 102 is described herein in terms of responding to requests for performing employee management from users at customer device 132 and other clients, as well as other systems communicably coupled to network 150 or directly connected to the server 102. However, the server 102 may, in some implementations, be a part of a larger system providing additional functionality. For example, server 102 may be part of an enterprise business application or application suite providing one or more of enterprise relationship management, data management systems, customer relationship management, and others. In one example, server 102 may receive a request to generate a skill and related skill dataset, obtain a large corpus of text (such as a large number of job descriptions), pre-process the large corpus of text using NLP techniques, train a machine learning model (such as a word2vec model) with the pre-processed text, extract skills from each pre-processed text document and form skill pairs, validate the skill pairs using the machine learning model, and respond to the request with the skill and related skill dataset including the validated skill pairs. The skill and related skill dataset can be queried with a skill, and return that skill's related skills. Those related skills may represent skills to be suggested for new skill training, related skills that may also be in the user's repertoire, but were forgotten on their resume or submission, or as a tool to identify related skills that may be useful for a candidate to have in a job description, among others. In some implementations, the server 102 may be associated with a particular uniform resource locator (URL) for web-based applications. The particular URL can trigger execution of multiple components and systems.

As illustrated, server 102 includes an interface 104, one or more processors 106, memory 108, and a skill management application 120. In general, the server 102 is a simplified representation of one or more systems and/or servers that provide the described functionality, and is not meant to be limiting, but rather an example of the systems possible.

The interface 104 is used by the server 102 for communicating with other systems in a distributed environment—including within the system 100—connected to the network 150 (e.g., customer device 132, third-party server 144, and other systems communicably coupled to the network 150). Generally, the interface 104 may comprise logic encoded in software and/or hardware in a suitable combination and operable to communicate with the network 150. More specifically, the interface 104 may comprise software supporting one or more communication protocols associated with communications, such that the network 150 or interface's hardware is operable to communicate physical signals within and outside of the illustrated system 100.

Network 150 facilitates wireless or wireline communications between the components of the system 100 (e.g., between server 102 and customer device 132 and among others), as well as with any other local or remote computer, such as additional clients, servers, or other devices communicably coupled to network 150, including those not illustrated in FIG. 1. In the illustrated system, the network 150 is depicted as a single network, but may be comprised of more than one network without departing from the scope of this disclosure, so long as at least a portion of the network 150 may facilitate communications between senders and recipients. In some instances, one or more of the illustrated components may be included within network 150 as one or more cloud-based services or operations. For example, the server 102 may be a cloud-based service. The network 150 may be all or a portion of an enterprise or secured network, while in another instance, at least a portion of the network 150 may represent a connection to the Internet. In some instances, a portion of the network 150 may be a virtual private network (VPN). Further, all or a portion of the network 150 can comprise either a wireline or wireless link. Example wireless links may include 802.11ac/ad/af/a/b/g/n, 802.20, WiMax, LTE, and/or any other appropriate wireless link. In other words, the network 150 encompasses any internal or external network, networks, sub-network, or combination thereof operable to facilitate communications between various computing components inside and outside the illustrated system 100. The network 150 may communicate, for example, Internet Protocol (IP) packets, Frame Relay frames, Asynchronous Transfer Mode (ATM) cells, voice, video, data, and other suitable information between network addresses. The network 150 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the server 102 includes one or more processors 106. Each processor 106 may include a central processing unit (CPU), an application-specific integrated circuit (ASIC), a field-programmable gate array (FPGA), or another suitable component. Generally, each processor 106 executes instructions and manipulates data to perform the operations of the server 102. Specifically, each processor 106 executes the algorithms and operations described in the illustrated figures, including the operations performing the functionality associated with the server 102 generally, as well as the various software modules (e.g., the skill management application 120), including the functionality for sending communications to and receiving transmissions from customer device 132.

The server 102 also includes the skill management application 120. The skill management application 120 provides machine learning based solutions for skill and related skills. In operation, the skill management application 120 may obtain a large corpus of text (such as a large number of job descriptions), pre-process the large corpus of text using NLP techniques, train a machine learning model with the pre-processed text, extract skills from each pre-processed text document and form skill pairs, validate the skill pairs using the machine learning model, and generate a skill and related skill dataset including the validated skill pairs. When queried with a skill, the skill management application 120 may return related skills based on the skill and related skill dataset. Operations of the skill management application 120 are executed by the one or more processors 106. In some implementations, the skill management application 120 may be a software program, or set of software programs, executing on the server 102. In various alternative implementations, the skill management application 120 may also be an external component from the server 102 and may communicate with the server 102 over a network (e.g., network 150).

As shown, the skill management application 120 includes the skill relation construction engine 122. The skill relation construction engine 122 can train a machine learning model 124 to establish word associations. In operation, the skill relation construction engine 122 may obtain training data (e.g., pre-processed textual data 112) and train the machine learning model 124 with the training data. Operations of the skill relation construction engine 122 are executed by the one or more processors 106. In some implementations, the skill relation construction engine 122 may be a software program, or set of software programs, executing on the server 102. In various alternative implementations, the skill relation construction engine 122 may also be an external component from the server 102 and may communicate with the server 102 over a network (e.g., network 150).

The skill relation construction engine 122 includes and/or interacts with the machine learning model 124. The machine learning model 124 is shown within the skill management application 120, but may be stored within memory 108 or any other suitable location. The machine learning model 124 can be trained using pre-processed textual data 112. For example, the machine learning model 124 can represent each distinct word with a particular list of numbers called a vector. A mathematical function (such as a cosine similarity function) can be used to indicate the level of semantic similarity between the words represented by the vectors. The machine learning model 124 can be trained using unsupervised learning approach. For example, the pre-processed textual data 112 can be used as input to train the machine learning model 124 using skip-gram architecture. After the machine learning model 124 is trained, the skill relation construction engine 122 can use the machine learning model 124 to validate skill pairs.

The skill management application 120 also includes the skill recommendation engine 126. The skill recommendation engine 126 represents a related skill recommendation service that automatically recommends or suggests related skills for a queried skill. For example, after receiving a related skill request for a particular skill from the customer device 132, the skill recommendation engine 126 can use the machine learning model 124 to identify a list of related skills for the particular skill, and provide, for presentation on the customer device 132, the list of related skills. In some implementations, the skill recommendation engine 126 can automatically add the list of related skills to a job description that has been submitted (such as a job bank automatically adding related skills to received job descriptions). In some instances, the skill recommendation engine 126 can present the list of related skills to a user of the customer device 132 and ask the user whether the list of related skills should be added to a digital resume/application. Operations of the skill recommendation engine 126 are executed by the one or more processors 106. In some implementations, the skill recommendation engine 126 may be a software program, or set of software programs, executing on the server 102. In various alternative implementations, the skill recommendation engine 126 may also be an external component from the server 102 and may communicate with the server 102 over a network (e.g., network 150).

Regardless of the particular implementation, “software” includes computer-readable instructions, firmware, wired and/or programmed hardware, or any combination thereof on a tangible medium (transitory or non-transitory, as appropriate) operable when executed to perform at least one of the processes and operations described herein. In fact, each software component may be fully or partially written or described in any appropriate computer language, including C, C++, JavaScript, JAVA™, VISUAL BASIC, assembler, Perl®, any suitable version of 4GL, as well as others. While portions of the software elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate.

As illustrated, server 102 includes memory 108. In some implementations, the server 102 includes multiple memories. The memory 108 may include any memory or database module and may take the form of volatile or non-volatile memory including, without limitation, magnetic media, optical media, random access memory (RAM), read-only memory (ROM), removable media, or any other suitable local or remote memory component. The memory 108 may store various objects or data, including financial and/or business data, application information including URLs and settings, user information, behavior and access rules, administrative settings, password information, caches, backup data, repositories storing business and/or dynamic information, and any other appropriate information including any parameters, variables, algorithms, instructions, rules, constraints, or references thereto associated with the purposes of the server 102. Additionally, the memory 108 may store any other appropriate data, such as VPN applications, firmware logs and policies, firewall policies, a security or access log, print or other reporting files, as well as others. For example, illustrated memory 108 includes textual data 110, pre-processed textual data 112, skills 114, and skill pairs 116.

The textual data 110 stores text documents. For example, the text documents can include job descriptions, resumes, or other textual documents. The text documents can be received from a third-party system (e.g., the third-party server 144). In some instances, the third-party server 144 is a job search engine that aggregates job listings from employer websites. NLP techniques can be used to perform one or more of Unicode normalization, unwanted character removal, and stopwords removal on each text document to obtain pre-processed text documents, which can be stored in the pre-processed textual data 112. The skills 114 stores skills extracted from the pre-processed text documents. For example, each skill is a word or a phrase in the pre-processed text documents. The skill pairs 116 stores skill pairs generated based on skill occurrence in the pre-processed text documents. For example, each skill pair includes two skills extracted from a same pre-processed text document.

Customer device 132 may be any computing device operable to connect to or communicate with server 102, third-party server 144, other clients (not illustrated), or other components via network 150, as well as with the network 150 itself, using a wireline or wireless connection, and can include a desktop computer, a mobile device, a tablet, a server, or any other suitable computer device. In general, customer device 132 comprises an electronic computer device operable to receive, transmit, process, and store any appropriate data associated with the system 100 of FIG. 1.

As illustrated, customer device 132 includes an interface 134, one or more processors 136, a graphical user interface (GUI) 142, a customer application 140, and memory 138. Interface 134 and one or more processors 136 may be similar to, or different than, interface 104 and one or more processors 106 described with regard to server 102. In general, each processor 136 executes instructions and manipulates data to perform the operations of the customer device 132. Specifically, each processor 136 can execute some or all of the algorithms and operations described in the illustrated figures, including the operations performing the functionality associated with the customer application 140 and the other components of customer device 132. Similarly, interface 134 provides the customer device 132 with the ability to communicate with other systems in a distributed environment—including within the system 100—connected to the network 150.

The customer device 132 includes or presents the GUI 142. For example, the GUI 142 provides a user interface between a user and the customer application 140. In operation, the user uses the GUI 142 to input data about a skill for which the user wants to find related skills. For example, the GUI 142 may display a field for the user to input the skill and to make a request to the server 102 for the related skills. In some implementations, the GUI 142 may display all the related skills returned by the server 102 next to the field for the user to consider. In some implementations, the GUI 142 may be a software program, or set of software programs, executing on the customer device 132. The GUI 142 may also be an external component from the customer device 132 and may communicate with the customer device 132 over a network (e.g., network 150).

The GUI 142 of the customer device 132 interfaces with at least a portion of the system 100 for any suitable purpose, including generating a visual representation of the customer application 140 and/or other applications. In particular, the GUI 142 may be used to view and navigate various Web pages, or other user interfaces. Generally, the GUI 142 provides the user with an efficient and user-friendly presentation of business data provided by or communicated within the system. The GUI 142 may comprise a plurality of customizable frames or views having interactive fields, pull-down lists, and buttons operated by the user. The GUI 142 contemplates any suitable graphical user interface, such as a combination of a generic web browser, intelligent engine, and command line interface (CLI) that processes information and efficiently presents the results to the user visually.

The customer device 132 can include one or more client applications, including the customer application 140. In general, a client application is any type of application that allows the customer device 132 to request and view content on the respective device. In some implementations, a client application can use parameters, metadata, and other information received at launch to access a particular set of data from the server 102. In some instances, a client application may be an agent or client-side version of the one or more enterprise applications running on an enterprise server (not shown).

Customer device 132 executes the customer application 140. The customer application 140 may operate with or without requests to the server 102—in other words, the customer application 140 may execute its functionality without requiring the server 102 in some instances, such as by accessing data stored locally on the customer device 132. In others, the customer application 140 may be operable to interact with the server 102 by sending requests via network 150 to the server 102 for performing machine learning based solutions for skill and related skills. For example, a user (such as, a manager and a human resources (HR) personnel) can use the customer application 140 to request related skills for an employee's listed skill. In some implementations, the customer application 140 may be a standalone web browser, while in others, the customer application 140 may be an application with a built-in browser. The customer application 140 can be a web-based application or a standalone application, developed for the particular customer device 132. For example, the customer application 140 can be a native iOS application for iPad, a desktop application for laptops, as well as others.

Memory 138 may be similar to or different from memory 108 of the server 102. In some implementations, the customer device 132 includes multiple memories. In general, memory 138 may store various objects or data, including any parameters, variables, algorithms, instructions, rules, constraints, or references thereto, associated with the purposes of the customer device 132. Additionally, the memory 138 may store any other appropriate data, such as VPN applications, firmware logs and policies, firewall policies, a security or access log, print or other reporting files, as well as others.

The illustrated customer device 132 is intended to encompass any computing device such as a desktop computer, laptop/notebook computer, mobile device, smartphone, personal data assistant (PDA), tablet computing device, one or more processors within these devices, or any other suitable processing device. For example, the customer device 132 may comprise a computer that includes an input device, such as a keypad, touch screen, or other device that can accept user information, and an output device that conveys information associated with the operation of the customer application 140 or the customer device 132 itself, including digital data, visual information, or the GUI 142, as shown with respect to the customer device 132. Further, while illustrated as a client system, customer device 132 may be exchanged with another suitable source for performing related skill recommendation in other implementations, and is not meant to be limiting.

There may be any number of customer devices 132 associated with, or external to, the system 100. For example, while the illustrated system 100 includes one customer device 132, alternative implementations of the system 100 may include multiple customer devices 132 communicably coupled to the server 102 and/or the network 150, or any other number suitable to the purposes of the system 100. Additionally, there may also be one or more additional customer devices 132 external to the illustrated portion of system 100 that are capable of interacting with the system 100 via the network 150. Further, the term “client”, “client device” and “user” may be used interchangeably as appropriate without departing from the scope of this disclosure. Moreover, while the customer device 132 is described in terms of being used by a single user, this disclosure contemplates that many users may use one computer, or that one user may use multiple computers.

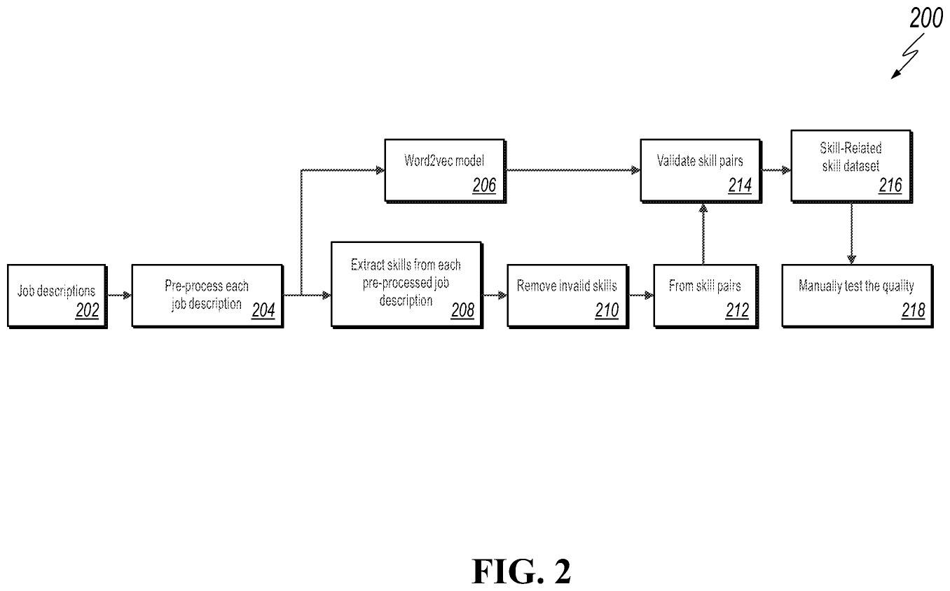

FIG. 2 is a flow diagram of an example process 200 for generating skill pairs based on a machine learning model. Operations of process 200 are described below as being performed by one or more components of the system 100 described above with respect to FIG. 1. For example, the process 200 can be executed by the server 102 of FIG. 1. Operations of the process 200 are described below for illustration purposes only. Operations of the process 200 can be performed by any appropriate device or system, e.g., any appropriate data processing apparatus. Operations of the process 200 can also be implemented as instructions stored on a non-transitory computer readable medium. Execution of the instructions causes one or more data processing apparatus to perform operations of the process 200.

At 202, job descriptions are obtained as a sample textual dataset for generating a skill and related skill dataset. For example, the job descriptions can be received from a third-party system (such as a job search engine that aggregates job listings from employer websites). The job descriptions can include a large number of usable job descriptions (such as 0.5 million) for different industries and different job titles (such as customer service represent and sales consultant). A job description can be one or more paragraphs in a job listing, and can include skills required for the particular job listing. For example, a job description of a support engineer can include responsibility information of the support engineer and/or information of an organization publishing the job description. The skills may be listed as a bulleted list, as a delimited set of skills, or, alternatively, may be included or described in a freeform paragraph describing the position and its requirements, such that skills must be extracted from the paragraph for identification. In some implementations, a set of resumes can be obtained as the sample textual dataset. In some instances, any text documents (such as blog posts) can be obtained as the sample textual dataset.

At 204, each job description is pre-processed to obtain a pre-processed job description. For example, NLP techniques can be used to perform one or more of Unicode normalization, unwanted character removal, and stopwords removal on each job description. In some implementations, one or more of language checking, Hypertext Markup Language (HTML) parsing, and extra space removal can also be performed. The pre-processed job descriptions can be used to both train a machine learning model at 206, and extract skills at 208.

At 206, a machine learning model is trained with the pre-processed job descriptions. As illustrated in 206, a word2vec model is used in this implementation, although other potential models may be used in others. Word2vec is an NLP technique, and can be used to establish word associations from a large corpus of text. Word2vec represents each distinct word with a particular list of numbers called a vector. A mathematical function (such as a cosine similarity function) can be executed to identify and indicate the level of semantic similarity between the words represented by the vectors. The word2vec model can be trained using unsupervised learning approach. For example, the pre-processed job descriptions can be used as input to train the word2vec model using skip-gram architecture. After the word2vec model has been trained, a word (e.g., a skill) in the pre-processed job descriptions can be queried with the word2vec model for similar words (e.g., related skills). Words having at least a predefined similarity score to the queried word can be returned by the word2vec model.

At 208, skills are extracted from each pre-processed job description. For example, a skill library can be used as a lookup dictionary to lookup skills in each pre-processed job description based on string matching. The skill library can include a large number of predefined skills (e.g., 34,000 skills). A skill from a pre-processed job description that matches any skill in the skill library can be extracted from the pre-processed job description. In some implementations, a skill can be a word or a phrase in a pre-processed job description.

At 210, invalid skills are removed from the skills extracted at 208. For example, skills extracted from a pre-processed job description are considered as one skill bucket. Skills from all skill buckets are sorted based on their frequencies of occurrence. Skills that occur too frequently and/or infrequently can be manually verified, and removed from their corresponding skill buckets if manual verification fails. In some implementations, skills can be automatically verified based on their frequencies of occurrence. For example, if a skill's frequency of occurrence is above a predefined threshold, the skill is automatically removed from its corresponding skill bucket. In doing so, the number of invalid skills in each skill bucket can be reduced, thereby reducing the total number of unique skills extracted from the pre-processed job descriptions.

At 212, skill pairs are formed for skills obtained at 210. Skill pairs can be generated based on their occurrence in the job descriptions. For example, for each skill bucket, skills obtained in the skill bucket are combined to form skill pairs. An assumption is made that skills occurring in a same job description are related to each other.

At 214, skill pairs are validated using the word2vec model. For example, to validate a skill pair of (A, B), A can be queried with the word2vec model for related skills having at least a predefined cosine similarity score (such as 70%) to A. If B is in the related skills returned by the word2vec model, the skill pair of (A, B) is validated. On the other hand, if B is not in the related skills returned by the word2vec model, the skill pair of (A, B) is not validated and is considered to be an invalid skill pair. The predefined cosine similarity score can be adjusted based on a desired quality of the skill pairs. For example, to increase quality of the skill pairs, the predefined cosine similarity score can be increased. Any valid skill pair includes two skills occurred in a same job description, and can be validated by the word2vec model.

At 216, a skill and related skill dataset is generated based on the validated skill pairs at 214. For example, each skill pair validated at 214 can be added into the skill and related skill dataset if the skill pair does not exist in the skill and related skill dataset.

At 218, quality of the skill and related skill dataset is manually tested. For example, after the skill and related skill dataset is generated, an administrator (such as, a manager and an HR personnel) can manually exam the skill and related skill dataset. One or more skill pairs can be removed by the administrator from the skill and related skill dataset. In some implementations, one or more new skill pairs can be added by the administrator to the skill and related skill dataset. In some implementations, after the administrator manually curates the skill and related skill dataset, the process of testing the skill and related skill dataset can be automatically performed.

The skill and related skill dataset generated by the process 200 can provide a query service for related skills. In some implementations, when queried with a skill, the skill and related skill dataset can return its related skills. For example, if “Machine Learning”, “NLP”, “Deep Learning”, and “Neural Networks” are related skills and an employee lists “Machine Learning” and “NLP” in his or her resume, “Deep Learning” and “Neural Networks” can be suggested for the employee to consider listing, if applicable, into the resume. In some implementations, the employee can be recommended to learn or take training in “Deep Learning” and “Neural Networks”, or automatically enrolled in “Deep Learning” and “Neural Networks” classes within an enterprise learning system. In some implementations, the employee can be recommended with positions in the fields of “Deep Learning” and “Neural Networks”. In some implementations, a job description can be automatically updated to include other related skills.

In some implementations, the process 200 can be performed as needed to update the skill pairs in the skill and related skill dataset. For example, the process 200 can be performed periodically to keep the skill and related skill dataset up to date. In some implementations, when an administrator notices that quality of the skill and related skill dataset decreases or notices some new skills in the market, the administrator can make a request to the server 102 of FIG. 1 to perform the process 200.

Table 1 provides an example result of validated skill pairs from one job description using the process 200. As shown in Table 1, 22 skills are extracted from one job description, and 484 skill pairs are formed. Using the word2vec model with a 70% cosine similarity score, only 16 validated skill pairs are obtained. Validated skill pairs obtained from other job descriptions are not shown in Table 1.

TABLE 1

| | | Validated skill |
|---|---|---|
| | | pairs with at |
| | | least 70% |
| Skills | Skills Pairs as per their occurrence | similarity |
| [‘web services’, | [(‘web services’, ‘web services’), (‘web | (‘web services’, |
| ‘professional services’, | services’, ‘professional services’), (‘web | ‘xml’) |
| ‘application’, ‘angular’, | services’, ‘application’), (‘web services’, | (‘spring |
| ‘project’, ‘debugging’, | ‘angular’), (‘web services’, ‘project’), | integration’, |
| ‘acting’, ‘spring | (‘web services’, ‘debugging’), (‘web | ‘spring boot’) |
| integration’, ‘profiling’, | services’, ‘acting’), (‘web services’, ‘spring | (‘microservices’, |
| ‘java enterprise edition’, | integration’), (‘web services’, ‘profiling’), | ‘spring boot’) |
| ‘microservices’, ‘less’, | (‘web services’, ‘java enterprise | (‘github’, |
| ‘jenkins’, ‘github’, ‘xml’, | edition’), (‘web services’, ‘microservices’), | ‘jenkins’) |
| ‘xslt’, ‘spring boot’, | (‘web services’, ‘less’), (‘web services’, | (‘xml’, ‘web |
| ‘digital’, ‘business logic’, | ‘jenkins’), (‘web services’, ‘github’), (‘web | services’) |
| ‘j2ee’, ‘java’, ‘sql’] | services’, ‘xml’), (‘web services’, ‘xslt’), | (‘xml’, ‘xslt’) |
| | (‘web services’, ‘spring boot’), (‘web | (‘xslt’, ‘xml’) |
| | services’, ‘digital’), (‘web services’, | (‘spring boot’, |
| | ‘business logic’), (‘web services’, ‘j2ee’), | ‘spring |
| | (‘web services’, ‘java’), (‘web services’, | integration’) |
| | ‘sql’), (‘professional services’, ‘web | (‘spring boot’, |
| | services’), (‘professional services’, | ‘j2ee’) |
| | ‘professional services’), (‘professional | (‘spring boot’, |
| | services’, ‘application’), (‘professional | ‘java’) |
| | services’, ‘angular’), (‘professional | (‘j2ee’, ‘web |
| | services’, ‘project’), (‘professional | services’) |
| | services’, ‘debugging’), (‘professional | (‘j2ee’, ‘spring |
| | services’, ‘acting’), (‘professional | boot’) |
| | services’, ‘spring | (‘j2ee’, ‘java’) |
| | integration’), (‘professional services’, | (‘java’, ‘angular’) |
| | ‘profiling’), (‘professional services’, ‘java | (‘java’, ‘spring |
| | enterprise edition’), (‘professional | boot’) |
| | services’, ‘microservices’), (‘professional | (‘java’, ‘j2ee’) |
| | services’, ‘less’), (‘professional services’, | |
| | ‘jenkins’), (‘professional services’, | |
| | ‘github’), (‘professional services’, ‘xml’), | |
| | (‘professional services’, | |
| | ‘xslt’), (‘professional services’, ‘spring | |
| | boot’), (‘professional services’, ‘digital’), | |
| | (‘professional services’, ‘business | |
| | logic’), (‘professional services’, ‘j2ee’), | |
| | (‘professional services’, ‘java’), | |
| | (‘professional services’, | |
| | ‘sql’), (‘application’, ‘web services’), | |
| | (‘application’, ‘professional services’), | |
| | (‘application’, | |
| | ‘application’), (‘application’, ‘angular’), | |
| | (‘application’, ‘project’), (‘application’, | |
| | ‘debugging’), (‘application’, | |
| | ‘acting’), (‘application’, ‘spring | |
| | integration’), (‘application’, ‘profiling’), | |
| | (‘application’, ‘java enterprise | |
| | edition’), (‘application’, ‘microservices’), | |
| | (‘application’, ‘less’), (‘application’, | |
| | ‘jenkins’), (‘application’, | |
| | ‘github’), (‘application’, ‘xml’), | |
| | (‘application’, ‘xslt’), (‘application’, | |
| | ‘spring boot’), (‘application’, | |
| | ‘digital’), (‘application’, ‘business logic’), | |
| | (‘application’, ‘j2ee’), (‘application’, | |
| | ‘java’), (‘application’, ‘sql’), (‘angular’, | |
| | ‘web services’), (‘angular’, ‘professional | |
| | services’), (‘angular’, ‘application’), | |
| | (‘angular’, ‘angular’), (‘angular’, ‘project’), | |
| | (‘angular’, ‘debugging’), (‘angular’, | |
| | ‘acting’), (‘angular’, ‘spring integration’), | |
| | (‘angular’, ‘profiling’), (‘angular’, ‘java | |
| | enterprise edition’), (‘angular’, | |
| | ‘microservices’), (‘angular’, ‘less’), | |
| | (‘angular’, ‘jenkins’), (‘angular’, | |
| | ‘github’), (‘angular’, ‘xml’), (‘angular’, | |
| | ‘xslt’), (‘angular’, ‘spring boot’), | |
| | (‘angular’, ‘digital’), (‘angular’, ‘business | |
| | logic’), (‘angular’, ‘j2ee’), (‘angular’, | |
| | ‘java’), (‘angular’, ‘sql’), (‘project’, ‘web | |
| | services’), (‘project’, ‘professional | |
| | services’), (‘project’, ‘application’), | |
| | (‘project’, ‘angular’), (‘project’, ‘project’), | |
| | (‘project’, ‘debugging’), (‘project’, | |
| | ‘acting’), (‘project’, ‘spring integration’), | |
| | (‘project’, ‘profiling’), (‘project’, ‘java | |
| | enterprise edition’), (‘project’, | |
| | ‘microservices’), (‘project’, ‘less’), | |
| | (‘project’, ‘jenkins’), (‘project’, ‘github’), | |
| | (‘project’, ‘xml’), (‘project’, ‘xslt’), | |
| | (‘project’, ‘spring boot’), (‘project’, | |
| | ‘digital’), (‘project’, ‘business logic’), | |
| | (‘project’, ‘j2ee’), (‘project’, ‘java’), | |
| | (‘project’, ‘sql’), (‘debugging’, ‘web | |
| | services’), (‘debugging’, ‘professional | |
| | services’), (‘debugging’, ‘application’), | |
| | (‘debugging’, ‘angular’), (‘debugging’, | |
| | ‘project’), (‘debugging’, ‘debugging’), | |
| | (‘debugging’, ‘acting’), (‘debugging’, | |
| | ‘spring integration’), (‘debugging’, | |
| | ‘profiling’), (‘debugging’, ‘java enterprise | |
| | edition’), (‘debugging’, ‘microservices’), | |
| | (‘debugging’, ‘less’), (‘debugging’, | |
| | ‘jenkins’), (‘debugging’, ‘github’), | |
| | (‘debugging’, ‘xml’), (‘debugging’, ‘xslt’), | |
| | (‘debugging’, ‘spring boot’), (‘debugging’, | |
| | ‘digital’), (‘debugging’, ‘business logic’), | |
| | (‘debugging’, ‘j2ee’), (‘debugging’, ‘java’), | |
| | (‘debugging’, ‘sql’), (‘acting’, ‘web | |
| | services’), (‘acting’, ‘professional | |
| | services’), (‘acting’, ‘application’), | |
| | (‘acting’, ‘angular’), (‘acting’, ‘project’), | |
| | (‘acting’, ‘debugging’), (‘acting’, ‘acting’), | |
| | (‘acting’, ‘spring integration’), (‘acting’, | |
| | ‘profiling’), (‘acting’, ‘java enterprise | |
| | edition’), (‘acting’, ‘microservices’), | |
| | (‘acting’, ‘less’), (‘acting’, ‘jenkins’), | |
| | (‘acting’, ‘github’), (‘acting’, ‘xml’), | |
| | (‘acting’, ‘xslt’), (‘acting’, ‘spring boot’), | |
| | (‘acting’, ‘digital’), (‘acting’, ‘business | |
| | logic’), (‘acting’, ‘j2ee’), (‘acting’, ‘java’), | |
| | (‘acting’, ‘sql’), (‘spring integration’, ‘web | |
| | services’), (‘spring integration’, | |
| | ‘professional services’), (‘spring | |
| | integration’, ‘application’), (‘spring | |
| | integration’, ‘angular’), (‘spring | |
| | integration’, ‘project’), (‘spring | |
| | integration’, ‘debugging’), (‘spring | |
| | integration’, ‘acting’), (‘spring | |
| | integration’, ‘spring integration’), (‘spring | |
| | integration’, ‘profiling’), (‘spring | |
| | integration’, ‘java enterprise edition’), | |
| | (‘spring integration’, ‘microservices’), | |
| | (‘spring integration’, ‘less’), (‘spring | |
| | integration’, ‘jenkins’), (‘spring | |
| | integration’, ‘github’), (‘spring | |
| | integration’, ‘xml’), (‘spring integration’, | |
| | ‘xslt’), (‘spring integration’, ‘spring boot’), | |
| | (‘spring integration’, ‘digital’), (‘spring | |
| | integration’, ‘business logic’), (‘spring | |
| | integration’, ‘j2ee’), (‘spring integration’, | |
| | ‘java’), (‘spring integration’, ‘sql’), | |
| | (‘profiling’, ‘web services’), (‘profiling’, | |
| | ‘professional services’), (‘profiling’, | |
| | ‘application’), (‘profiling’, ‘angular’), | |
| | (‘profiling’, ‘project’), (‘profiling’, | |
| | ‘debugging’), (‘profiling’, ‘acting’), | |
| | (‘profiling’, ‘spring integration’), | |
| | (‘profiling’, ‘profiling’), (‘profiling’, ‘java | |
| | enterprise edition’), (‘profiling’, | |
| | ‘microservices’), (‘profiling’, ‘less’), | |
| | (‘profiling’, ‘jenkins’), (‘profiling’, | |
| | ‘github’), (‘profiling’, ‘xml’), (‘profiling’, | |
| | ‘xslt’), (‘profiling’, ‘spring boot’), | |
| | (‘profiling’, ‘digital’), (‘profiling’, | |
| | ‘business logic’), (‘profiling’, ‘j2ee’), | |
| | (‘profiling’, ‘java’), (‘profiling’, ‘sql’), | |
| | (‘java enterprise edition’, ‘web services’), | |
| | (‘java enterprise edition’, ‘professional | |
| | services’), (‘java enterprise edition’, | |
| | ‘application’), (‘java enterprise edition’, | |
| | ‘angular’), (‘java enterprise edition’, | |
| | ‘project’), (‘java enterprise edition’, | |
| | ‘debugging’), (‘java enterprise edition’, | |
| | ‘acting’), (‘java enterprise edition’, ‘spring | |
| | integration’), (‘java enterprise edition’, | |
| | ‘profiling’), (‘java enterprise edition’, | |
| | ‘java enterprise edition’), (‘java enterprise | |
| | edition’, ‘microservices’), (‘java | |
| | enterprise edition’, ‘less’), (‘java | |
| | enterprise edition’, ‘jenkins’), (‘java | |
| | enterprise edition’, ‘github’), (‘java | |
| | enterprise edition’, ‘xml’), (‘java | |
| | enterprise edition’, ‘xslt’), (‘java | |
| | enterprise edition’, ‘spring boot’), (‘java | |
| | enterprise edition’, ‘digital’), (‘java | |
| | enterprise edition’, ‘business logic’), | |
| | (‘java enterprise edition’, ‘j2ee’), (‘java | |
| | enterprise edition’, ‘java’), (‘java | |
| | enterprise edition’, ‘sql’), | |
| | (‘microservices’, ‘web services’), | |
| | (‘microservices’, ‘professional services’), | |
| | (‘microservices’, ‘application’), | |
| | (‘microservices’, ‘angular’), | |
| | (‘microservices’, ‘project’), | |
| | (‘microservices’, ‘debugging’), | |
| | (‘microservices’, ‘acting’), | |
| | (‘microservices’, ‘spring integration’), | |
| | (‘microservices’, ‘profiling’), | |
| | (‘microservices’, ‘java enterprise | |
| | edition’), (‘microservices’, | |
| | ‘microservices’), (‘microservices’, ‘less’), | |
| | (‘microservices’, ‘jenkins’), | |
| | (‘microservices’, ‘github’), | |
| | (‘microservices’, ‘xml’), (‘microservices’, | |
| | ‘xslt’), (‘microservices’, ‘spring boot’), | |
| | (‘microservices’, ‘digital’), | |
| | (‘microservices’, ‘business logic’), | |
| | (‘microservices’, ‘j2ee’), (‘microservices’, | |
| | ‘java’), (‘microservices’, ‘sql’), (‘less’, | |
| | ‘web services’), (‘less’, ‘professional | |
| | services’), (‘less’, ‘application’), (‘less’, | |
| | ‘angular’), (‘less’, ‘project’), (‘less’, | |
| | ‘debugging’), (‘less’, ‘acting’), (‘less’, | |
| | ‘spring integration’), (‘less’, ‘profiling’), | |
| | (‘less’, ‘java enterprise edition’), (‘less’, | |
| | ‘microservices’), (‘less’, ‘less’), (‘less’, | |
| | ‘jenkins’), (‘less’, ‘github’), (‘less’, ‘xml’), | |
| | (‘less’, ‘xslt’), (‘less’, ‘spring boot’), (‘less’, | |
| | ‘digital’), (‘less’, ‘business logic’), (‘less’, | |
| | ‘j2ee’), (‘less’, ‘java’), (‘less’, ‘sql’), | |
| | (‘jenkins’, ‘web services’), (‘jenkins’, | |
| | ‘professional services’), (‘jenkins’, | |
| | ‘application’), (‘jenkins’, ‘angular’), | |
| | (‘jenkins’, ‘project’), (‘jenkins’, | |
| | ‘debugging’), (‘jenkins’, ‘acting’), | |
| | (‘jenkins’, ‘spring integration’), (‘jenkins’, | |
| | ‘profiling’), (‘jenkins’, ‘java enterprise | |
| | edition’), (‘jenkins’, ‘microservices’), | |
| | (‘jenkins’, ‘less’), (‘jenkins’, ‘jenkins’), | |
| | (‘jenkins’, ‘github’), (‘jenkins’, ‘xml’), | |
| | (‘jenkins’, ‘xslt’), (‘jenkins’, ‘spring boot’), | |
| | (‘jenkins’, ‘digital’), (‘jenkins’, ‘business | |
| | logic’), (‘jenkins’, ‘j2ee’), (‘jenkins’, | |
| | ‘java’), (‘jenkins’, ‘sql’), (‘github’, ‘web | |
| | services’), (‘github’, ‘professional | |
| | services’), (‘github’, ‘application’), | |
| | (‘github’, ‘angular’), (‘github’, ‘project’), | |
| | (‘github’, ‘debugging’), (‘github’, ‘acting’), | |
| | (‘github’, ‘spring integration’), (‘github’, | |
| | ‘profiling’), (‘github’, ‘java enterprise | |
| | edition’), (‘github’, ‘microservices’), | |
| | (‘github’, ‘less’), (‘github’, ‘jenkins’), | |
| | (‘github’, ‘github’), (‘github’, ‘xml’), | |
| | (‘github’, ‘xslt’), (‘github’, ‘spring boot’), | |
| | (‘github’, ‘digital’), (‘github’, ‘business | |
| | logic’), (‘github’, ‘j2ee’), (‘github’, ‘java’), | |
| | (‘github’, ‘sql’), (‘xml’, ‘web services’), | |
| | (‘xml’, ‘professional services’), (‘xml’, | |
| | ‘application’), (‘xml’, ‘angular’), (‘xml’, | |
| | ‘project’), (‘xml’, ‘debugging’), (‘xml’, | |
| | ‘acting’), (‘xml’, ‘spring integration’), | |
| | (‘xml’, ‘profiling’), (‘xml’, ‘java enterprise | |
| | edition’), (‘xml’, ‘microservices’), (‘xml’, | |
| | ‘less’), (‘xml’, ‘jenkins’), (‘xml’, ‘github’), | |
| | (‘xml’, ‘xml’), (‘xml’, ‘xslt’), (‘xml’, ‘spring | |
| | boot’), (‘xml’, ‘digital’), (‘xml’, ‘business | |
| | logic’), (‘xml’, ‘j2ee’), (‘xml’, ‘java’), | |
| | (‘xml’, ‘sql’), (‘xslt’, ‘web services’), | |
| | (‘xslt’, ‘professional services’), (‘xslt’, | |
| | ‘application’), (‘xslt’, ‘angular’), (‘xslt’, | |
| | ‘project’), (‘xslt’, ‘debugging’), (‘xslt’, | |
| | ‘acting’), (‘xslt’, ‘spring integration’), | |
| | (‘xslt’, ‘profiling’), (‘xslt’, ‘java enterprise | |
| | edition’), (‘xslt’, ‘microservices’), (‘xslt’, | |
| | ‘less’), (‘xslt’, ‘jenkins’), (‘xslt’, ‘github’), | |
| | (‘xslt’, ‘xml’), (‘xslt’, ‘xslt’), (‘xslt’, ‘spring | |
| | boot’), (‘xslt’, ‘digital’), (‘xslt’, ‘business | |
| | logic’), (‘xslt’, ‘j2ee’), (‘xslt’, ‘java’), (‘xslt’, | |
| | ‘sql’), (‘spring boot’, ‘web services’), | |
| | (‘spring boot’, ‘professional services’), | |
| | (‘spring boot’, ‘application’), (‘spring | |
| | boot’, ‘angular’), (‘spring boot’, ‘project’), | |
| | (‘spring boot’, ‘debugging’), (‘spring | |
| | boot’, ‘acting’), (‘spring boot’, ‘spring | |
| | integration’), (‘spring boot’, ‘profiling’), | |
| | (‘spring boot’, ‘java enterprise edition’), | |
| | (‘spring boot’, ‘microservices’), (‘spring | |
| | boot’, ‘less’), (‘spring boot’, ‘jenkins’), | |
| | (‘spring boot’, ‘github’), (‘spring boot’, | |
| | ‘xml’), (‘spring boot’, ‘xslt’), (‘spring | |
| | boot’, ‘spring boot’), (‘spring boot’, | |
| | ‘digital’), (‘spring boot’, ‘business logic’), | |
| | (‘spring boot’, ‘j2ee’), (‘spring boot’, | |
| | ‘java’), (‘spring boot’, ‘sql’), (‘digital’, | |
| | ‘web services’), (‘digital’, ‘professional | |
| | services’), (‘digital’, ‘application’), | |
| | (‘digital’, ‘angular’), (‘digital’, ‘project’), | |
| | (‘digital’, ‘debugging’), (‘digital’, ‘acting’), | |
| | (‘digital’, ‘spring integration’), (‘digital’, | |
| | ‘profiling’), (‘digital’, ‘java enterprise | |
| | edition’), (‘digital’, ‘microservices’), | |
| | (‘digital’, ‘less’), (‘digital’, ‘jenkins’), | |
| | (‘digital’, ‘github’), (‘digital’, ‘xml’), | |
| | (‘digital’, ‘xslt’), (‘digital’, ‘spring boot’), | |
| | (‘digital’, ‘digital’), (‘digital’, ‘business | |
| | logic’), (‘digital’, ‘j2ee’), (‘digital’, ‘java’), | |
| | (‘digital’, ‘sql’), (‘business logic’, ‘web | |
| | services’), (‘business logic’, ‘professional | |
| | services’), (‘business logic’, | |
| | ‘application’), (‘business logic’, ‘angular’), | |
| | (‘business logic’, ‘project’), (‘business | |
| | logic’, ‘debugging’), (‘business logic’, | |
| | ‘acting’), (‘business logic’, ‘spring | |
| | integration’), (‘business logic’, | |
| | ‘profiling’), (‘business logic’, ‘java | |
| | enterprise edition’), (‘business logic’, | |
| | ‘microservices’), (‘business logic’, ‘less’), | |
| | (‘business logic’, ‘jenkins’), (‘business | |
| | logic’, ‘github’), (‘business logic’, ‘xml’), | |
| | (‘business logic’, ‘xslt’), (‘business logic’, | |
| | ‘spring boot’), (‘business logic’, ‘digital’), | |
| | (‘business logic’, ‘business logic’), | |
| | (‘business logic’, ‘j2ee’), (‘business logic’, | |
| | ‘java’), (‘business logic’, ‘sql’), (‘j2ee’, | |
| | ‘web services’), (‘j2ee’, ‘professional | |
| | services’), (‘j2ee’, ‘application’), (‘j2ee’, | |
| | ‘angular’), (‘j2ee’, ‘project’), (‘j2ee’, | |
| | ‘debugging’), (‘j2ee’, ‘acting’), (‘j2ee’, | |
| | ‘spring integration’), (‘j2ee’, ‘profiling’), | |
| | (‘j2ee’, ‘java enterprise edition’), (‘j2ee’, | |
| | ‘microservices’), (‘j2ee’, ‘less’), (‘j2ee’, | |
| | ‘jenkins’), (‘j2ee’, ‘github’), (‘j2ee’, ‘xml’), | |
| | (‘j2ee’, ‘xslt’), (‘j2ee’, ‘spring boot’), | |
| | (‘j2ee’, ‘digital’), (‘j2ee’, ‘business logic’), | |
| | (‘j2ee’, ‘j2ee’), (‘j2ee’, ‘java’), (‘j2ee’, ‘sql’), | |
| | (‘java’, ‘web services’), (‘java’, | |
| | ‘professional services’), (‘java’, | |
| | ‘application’), (‘java’, ‘angular’), (‘java’, | |
| | ‘project’), (‘java’, ‘debugging’), (‘java’, | |
| | ‘acting’), (‘java’, ‘spring integration’), | |
| | (‘java’, ‘profiling’), (‘java’, ‘java enterprise | |
| | edition’), (‘java’, ‘microservices’), (‘java’, | |
| | ‘less’), (‘java’, ‘jenkins’), (‘java’, ‘github’), | |
| | (‘java’, ‘xml’), (‘java’, ‘xslt’), (‘java’, | |
| | ‘spring boot’), (‘java’, ‘digital’), (‘java’, | |
| | ‘business logic’), (‘java’, ‘j2ee’), (‘java’, | |
| | ‘java’), (‘java’, ‘sql’), (‘sql’, ‘web | |
| | services’), (‘sql’, ‘professional services’), | |
| | (‘sql’, ‘application’), (‘sql’, ‘angular’), | |
| | (‘sql’, ‘project’), (‘sql’, ‘debugging’), (‘sql’, | |
| | ‘acting’), (‘sql’, ‘spring integration’), (‘sql’, | |
| | profiling’), (‘sql’, ‘java enterprise | |
| | edition’), (‘sql’, ‘microservices’), (‘sql’, | |
| | ‘less’), (‘sql’, ‘jenkins’), (‘sql’, ‘github’), | |
| | (‘sql’, ‘xml’), (‘sql’, ‘xslt’), (‘sql’, ‘spring | |
| | boot’), (‘sql’, ‘digital’), (‘sql’, ‘business | |
| | logic’), (‘sql’, ‘j2ee’), (‘sql’, ‘java’), (‘sql’, | |
| | ‘sql’)] | |

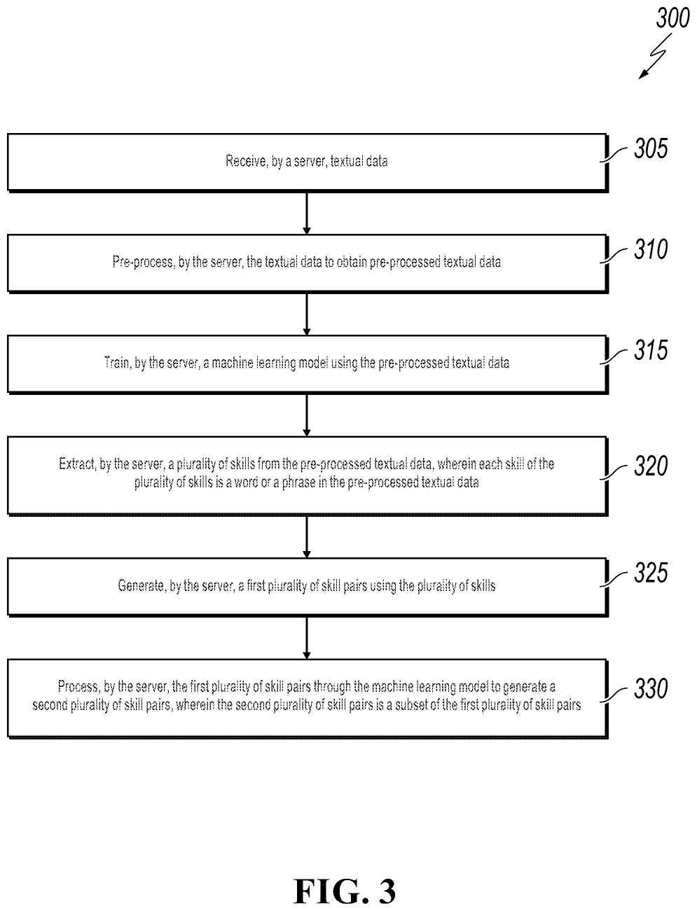

FIG. 3 is a flowchart of an example method 300 for generating a skill and related skill dataset based on machine learning. It will be understood that method 300 and related methods may be performed, for example, by any suitable system, environment, software, and hardware, or a combination of systems, environments, software, and hardware, as appropriate. For example, one or more of a client, a server, or other computing device can be used to execute method 300 and related methods and obtain any data from the memory of a client, the server, or the other computing device. In some implementations, the method 300 and related methods are executed by one or more components of the system 100 described above with respect to FIG. 1. For example, the method 300 and related methods can be executed by the server 102 of FIG. 1.

At 305, a server receives textual data. For example, the textual data can be received from a third-party system (such as a job search engine that aggregates job listings from employer websites). The textual data can be job descriptions, resumes, or other textual documents. The job descriptions are associated with different industries and/or different job titles. A job description can be one or more paragraphs in a job listing, and include skills required for the particular job listing. For example, a job description of a support engineer can include responsibility information of the support engineer and/or information of an organization publishing the job description.

At 310, the server pre-processes the textual data to obtain pre-processed textual data. For example, each text document (such as, a job description and a resume) in the textual data can be pre-processed to obtain pre-processed text document. In some implementations, the textual data can include both job descriptions and resumes. NLP techniques can be used to perform one or more of Unicode normalization, unwanted character removal, and stopwords removal on each text document.

At 315, the server trains a machine learning model using the pre-processed textual data. For example, the machine learning model can include a word2vec model. Word2vec is an NLP technique, and can be used to establish word associations from a large corpus of text. Word2vec represents each distinct word with a particular list of numbers called a vector. A mathematical function (such as a cosine similarity function) can be executed to identify and indicate the level of semantic similarity between the words represented by the vectors. The word2vec model can be trained using unsupervised learning approach. For example, the pre-processed textual data can be used as input to train the word2vec model using skip-gram architecture. After the word2vec model has been trained, a word (e.g., a skill) in the pre-processed textual data can be queried with the word2vec model for similar words (e.g., related skills). Words having at least a predefined similarity score to the queried word can be returned by the word2vec model.

At 320, the server extracts a plurality of skills from the pre-processed textual data. Each skill of the plurality of skills is a word or a phrase in the pre-processed textual data. For example, a skill library can be used as a lookup dictionary to lookup skills in each pre-processed text document based on string matching. The skill library can include a large number of predefined skills (e.g., 34,000 skills). A skill from a pre-processed text document that matches any skill in the skill library can be extracted from the pre-processed text document.

In some implementations, invalid skills can be removed from the plurality of skills. For example, skills extracted from a pre-processed text document are considered as one skill bucket. Skills from all skill buckets are sorted based on their frequencies of occurrence. Skills that occur too frequently and/or infrequently can be manually verified, and removed from their corresponding skill buckets if manual verification fails.

At 325, the server generates a first plurality of skill pairs using the plurality of skills. Skill pairs can be generated based on their occurrence in the pre-processed text documents. Each skill pair of the first plurality of skill pairs includes two skills extracted from a same pre-processed textual data (such as a same job description or a same resume). For example, for each skill bucket, skills obtained in the skill bucket are combined to form skill pairs. An assumption is made that skills occurring in a same text document are related to each other. In some implementations, one or more skill pairs can be manually verified, and removed from the first plurality of skill pairs if manual verification fails.

At 330, the server processes the first plurality of skill pairs through the machine learning model to generate a second plurality of skill pairs. The second plurality of skill pairs is a subset of the first plurality of skill pairs. For example, for each skill pair of the first plurality of skill pairs, a cosine similarity score is calculated using the machine learning model. If a cosine similarity score for a particular skill pair is higher than a predefined threshold, the particular skill pair is added to the second plurality of skill pairs. The predefined threshold can be set to 70%. In some implementations, one or more skill pairs can be manually verified, and removed from the second plurality of skill pairs if manual verification fails. In some implementations, one or more new skill pairs can be manually added to the second plurality of skill pairs.

In some implementations, after the second plurality of skill pairs is generated, a skill input by a user is identified. A list of related skills is generated for the skill input by the user based on the second plurality of skill pairs. One or more related skills are automatically identified from the list of related skills to the user. The identified one or more related skills are provided for presentation to the user.

In some implementations, the skill input by the user is a skill of the user. Generating the list of related skills comprises querying the second plurality of skill pairs with the skill input by the user, receiving a plurality of related skills, where each related skill of the plurality of related skills and the skill input by the user is a pair in the second plurality of skill pairs, and generating the list of related skills based on the plurality of related skills.

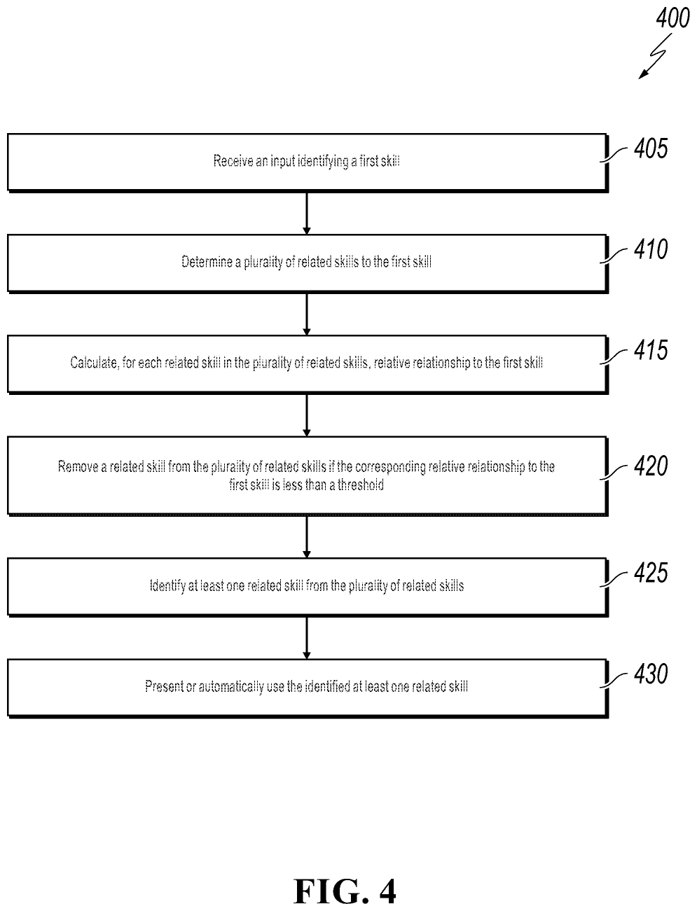

FIG. 4 is a flowchart of an example method 400 for identifying related skills to an input skill. It will be understood that method 400 and related methods may be performed, for example, by any suitable system, environment, software, and hardware, or a combination of systems, environments, software, and hardware, as appropriate. For example, one or more of a client, a server, or other computing device can be used to execute method 400 and related methods and obtain any data from the memory of a client, the server, or the other computing device. In some implementations, the method 400 and related methods are executed by one or more components of the system 100 described above with respect to FIG. 1. For example, the method 400 and related methods can be executed by the server 102 of FIG. 1.

At 405, an input identifying a first skill is received. The first skill can be a word or a phrase in a job description or a resume. The input can be provided by a user entering the first skill in an input space. For example, an employee enters “sql”, which is listed as a skill in his or her resume, and wants to identify some related skills that can be added into the resume. In some implementations, a job description or a resume is analyzed, and skills in the job description or the resume are identified. One of the identified skills is received or identified as the first skill for recommending related skills, and can be provided as the input.

At 410, a plurality of related skills to the first skill are determined. For example, a skill library can be used as a lookup dictionary to lookup skills in the job description or the resume based on string matching. The skill library can include a large number of predefined skills (e.g., 34,000 skills). A skill from the job description or the resume that matches any skill in the skill library can be put into the plurality of related skills.

At 415, for each related skill in the plurality of related skills, a relative relationship to the first skill is calculated. For example, each related skill and the first skill can be input into a machine learning model (such as a word2vec model) to calculate a similarity score (such as a cosine similarity score).

At 420, a related skill is removed from the plurality of related skills if the corresponding relative relationship to the first skill is less than a threshold. For example, if a particular related skill and the first skill have a cosine similarity score that is less than 70%, the particular related skill is considered to be unrelated to the first skill, and is removed from the plurality of related skills.

At 425, at least one related skill is identified from the plurality of related skills. For example, after removing unrelated skills from the plurality of related skills at 420, each skill in the plurality of related skills is considered related to the first skill. One or more skills can be identified from the plurality of related skills as related skills to the first skill.

At 430, the identified at least one related skill is presented or automatically used. For example, the identified at least one related skill can be presented on a screen for a user to consider. In some implementations, the identified at least one related skill can be automatically added to a job description or a digital resume/application of the user.

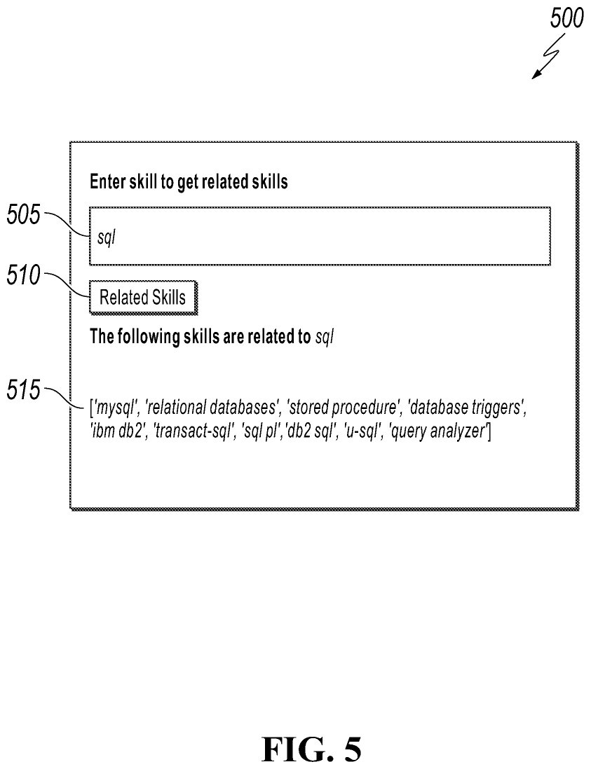

FIG. 5 is an example snapshot 500 of presenting related skills to an input skill. As shown in FIG. 5, after a user enters a skill “sql” at an input place 505, and clicks a button for related skills 510, the related skills to “sql” are presented at an output space 515. The related skills to “sql” are “mysql”, “relational databases”, “stored procedure”, “database triggers”, “ibm db2”, “transact-sql”, “sql pl”, “db2 sql”, “u-sql”, and “query analyzer”.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving, by a server, textual data;
pre-processing, by the server, the textual data to obtain pre-processed textual data;
training, by the server, a machine learning model using the pre-processed textual data;
extracting, by the server, a plurality of skills from the pre-processed textual data, wherein each skill of the plurality of skills is a word or a phrase in the pre-processed textual data;
generating, by the server, a first plurality of skill pairs using the plurality of skills; and
processing, by the server, the first plurality of skill pairs through the machine learning model to generate a second plurality of skill pairs, wherein the second plurality of skill pairs is a subset of the first plurality of skill pairs.

2. The computer-implemented method of claim 1, further comprising:
identifying a skill input by a user;
generating a list of related skills for the skill input by the user based on the second plurality of skill pairs;
automatically identifying one or more related skills from the list of related skills to the user; and
providing, for presentation to the user, the identified one or more related skills.

3. The computer-implemented method of claim 2, wherein the skill input by the user is a skill of the user, and generating the list of related skills comprises:
querying the second plurality of skill pairs with the skill input by the user, and receiving a plurality of related skills, wherein each related skill of the plurality of related skills and the skill input by the user is a pair in the second plurality of skill pairs; and
generating the list of related skills based on the plurality of related skills.

4. The computer-implemented method of claim 1, wherein the textual data includes at least one of a plurality of job descriptions, associated with different industries and different job titles, or a plurality of resumes, and is received from a third-party system.

5. The computer-implemented method of claim 4, wherein each skill pair of the first plurality of skill pairs includes two skills extracted from a same job description or a same resume.

6. The computer-implemented method of claim 1, wherein processing the first plurality of skill pairs through the machine learning model comprises:
for each skill pair of the first plurality of skill pairs:
calculating a cosine similarity score for the skill pair using the machine learning model; and
adding the skill pair to the second plurality of skill pairs if the cosine similarity score for the skill pair is higher than a threshold.

7. The computer-implemented method of claim 6, wherein the threshold is 70%.

8. The computer-implemented method of claim 1, wherein pre-processing the textual data comprises at least one of stopwords removal, Unicode normalization, or unwanted character removal.

9. The computer-implemented method of claim 1, wherein the machine learning model includes a word2vec model.

10. The computer-implemented method of claim 1, further comprising at least one of:
manually removing one or more skills from the plurality of skills;
manually removing one or more skill pairs from the first plurality of skill pairs; or
manually adding one or more skill pairs to the second plurality of skill pairs.

11. A system comprising:
one or more computers; and
a computer-readable medium coupled to the one or more computers having instructions stored thereon which, when executed by the one or more computers, cause the one or more computers to perform operations comprising:
receiving, by a server, textual data;
pre-processing, by the server, the textual data to obtain pre-processed textual data;
training, by the server, a machine learning model using the pre-processed textual data;
extracting, by the server, a plurality of skills from the pre-processed textual data, wherein each skill of the plurality of skills is a word or a phrase in the pre-processed textual data;
generating, by the server, a first plurality of skill pairs using the plurality of skills; and
processing, by the server, the first plurality of skill pairs through the machine learning model to generate a second plurality of skill pairs, wherein the second plurality of skill pairs is a subset of the first plurality of skill pairs.

12. The system of claim 11, the operations further comprising:
identifying a skill input by a user;
generating a list of related skills for the skill input by the user based on the second plurality of skill pairs;
automatically identifying one or more related skills from the list of related skills to the user; and
providing, for presentation to the user, the identified one or more related skills.

13. The system of claim 12, wherein the skill input by the user is a skill of the user, and generating the list of related skills comprises:
querying the second plurality of skill pairs with the skill input by the user, and receiving a plurality of related skills, wherein each related skill of the plurality of related skills and the skill input by the user is a pair in the second plurality of skill pairs; and
generating the list of related skills based on the plurality of related skills.

14. The system of claim 11, wherein the textual data includes at least one of a plurality of job descriptions, associated with different industries and different job titles, or a plurality of resumes, and is received from a third-party system.

15. The system of claim 14, wherein each skill pair of the first plurality of skill pairs includes two skills extracted from a same job description or a same resume.

16. The system of claim 11, wherein processing the first plurality of skill pairs through the machine learning model comprises:
for each skill pair of the first plurality of skill pairs:
calculating a cosine similarity score for the skill pair using the machine learning model; and
adding the skill pair to the second plurality of skill pairs if the cosine similarity score for the skill pair is higher than a threshold.

17. The system of claim 16, wherein the threshold is 70%.

18. The system of claim 11, wherein pre-processing the textual data comprises at least one of stopwords removal, Unicode normalization, or unwanted character removal.

19. The system of claim 11, wherein the machine learning model includes a word2vec model.

20. A computer program product encoded on a non-transitory storage medium, the product comprising non-transitory, computer readable instructions for causing one or more processors to perform operations comprising:
receiving, by a server, textual data;
pre-processing, by the server, the textual data to obtain pre-processed textual data;
training, by the server, a machine learning model using the pre-processed textual data;
extracting, by the server, a plurality of skills from the pre-processed textual data, wherein each skill of the plurality of skills is a word or a phrase in the pre-processed textual data;
generating, by the server, a first plurality of skill pairs using the plurality of skills; and
processing, by the server, the first plurality of skill pairs through the machine learning model to generate a second plurality of skill pairs, wherein the second plurality of skill pairs is a subset of the first plurality of skill pairs.
